(19) United States
(12) Patent Application Publication
(10) Pub. No.: US 2011/0080536 A1
(43) Pub. Date: Apr. 7, 2011

(54) STEREOSCOPIC IMAGE DISPLAY APPARATUS

(75) Inventors: Katsushige Nakamura, Tokyo (JP); Shuji Inaba, Tokyo (JP)

(73) Assignee: MITAKA KOHKI CO., LTD., Tokyo (JP)

(21) Appl. No.: 12/994,781

(22) PCT Filed: May 26, 2009
(86) PCT No.: PCT/JP2009/059599

§ 371 Date: Nov. 26, 2010

(30) Foreign Application Priority Data
May 27, 2008 (JP) 2008-137799

(51) Int. Cl. G02B 27/22; G02F 1/1335

(52) U.S. Cl. 349/15

(57) ABSTRACT

An electronic image display panel is a reflective liquid crystal panel. With respect to the surface of the electronic image display panel, an optical axis of an eyepiece lens is perpendicular. The optical axis passes through a central part of the electronic image display panel that is a main observation point of an observer. When observing the electronic image display panel, a visual axis of an eye of the observer forms no large angle with respect to the electronic image display panel and the observer can stereoscopically observe electronic images displayed on the electronic image display panels at an original binocular parallax provided by an objective lens of a surgical microscope. As a result, the observer feels no eye fatigue or headache even when observing the images for a long time.

### TECHNICAL FIELD

The present invention relates to a stereoscopic image display apparatus.

### BACKGROUND TECHNOLOGY

There is known a stereoscopic image display apparatus that photographs, with a photographing device such as a surgical microscope and a digital video camera, electronic images having binocular parallax for left and right eyes to realize a stereoscopic view and displays the pair of left and right electronic images on a pair of left and right electronic image display panels, so that an observer may watch a stereoscopic image when viewing the displayed electronic images through left and right eyepiece lenses, respectively.

The stereoscopic image display apparatus of this kind employs wedge-like prisms for the eyepiece lenses, to widen an angle between the left and right visual axes of an observer to a predetermined angle so that the observer may observe the respective central parts of the left and right electronic image display panels. The electronic image display panels each are usually a transmissive liquid crystal panel having a backlight on the back face thereof as disclosed in Japanese Patent Publication No. 2607828.

### OUTLINE OF INVENTION

### Problems to be Solved by Invention

The related art mentioned above photographs a pair of electronic images at a predetermined binocular parallax with a photographing device such as a surgical microscope and a digital video camera and further angles the pair of electronic images when presenting the images for observation through the eyepiece lenses. This technique has a drawback to cause a headache for an observer when the observer observes images on the display apparatus for a long time in, for example, brain surgery.

When a person watches an object, the right and left eyes of the person each move toward the inner canthus so that an image of the object may be formed at the central part of the retina. At this time, visual lines of the right and left eyes form an angle (convergent angle) to produce a difference (binocular parallax) between images viewed by the left and right eyes. The binocular parallax is reconciled by an action of the brain, to stereoscopically sense a depth of the object.

A photographing device such as a surgical microscope or a digital video camera forms a convergent angle by refraction of an objective lens and is designed to provide an ergonomically optimum convergent angle so that the eyes of an observer may not be fatigued.

According to the related art, electronic images photographed to have an optimum convergent angle and binocular parallax are further angled by the stereoscopic image display apparatus and are then observed. As a result, the optimum binocular parallax will lose accuracy and the brain must internally correct the inaccuracy, so that the brain unnoticeably accumulates fatigue to cause eye fatigue and a headache.

In addition, the transmissive electronic image display panel having a backlight on the back face thereof is hardly miniaturized. The difficulty of miniaturization of the electronic image display panel and the certain size of the electronic image display panel are the causes why the left and right visual axes of an observer must be widened to a predetermined angle.

In consideration of the related art, the present invention provides a stereoscopic image display apparatus that allows a long-time observation without fatigue.

### MEANS FOR SOLVING PROBLEMS

According to a technical aspect of the present invention, there is provided a stereoscopic image display apparatus having a pair of left and right electronic image display panels disposed in a casing, to respectively display a pair of left and right electronic images having binocular parallax and a pair of left and right eyepiece lenses arranged in the casing opposite to the electronic image display panels, respectively, the electronic image display panels being observed through the corresponding eyepiece lenses, to observe a stereoscopic image. In this stereoscopic image display apparatus, an optical axis of each of the eyepiece lenses is defined as being perpendicular to the corresponding electronic image display panel and each of the electronic image display panels is a reflective liquid crystal panel whose surface is illuminated with illumination light from a light source.

In the stereoscopic image display apparatus, the optical axis of each eyepiece lens agrees with a central part of the corresponding electronic image display panel.

A light branching unit is arranged on the optical axis between the electronic image display panel and the eyepiece lens. The illumination light from the light source illuminates the electronic image display panel through the light branching unit and an image on the electronic image display panel reaches the eyepiece lens through the light branching unit.

### BRIEF DESCRIPTION OF DRAWINGS

FIG. 1 is a perspective view illustrating a stereoscopic image display apparatus according to a first embodiment of the present invention.

FIG. 2 is an explanatory view illustrating an optical system of a surgical microscope.

FIG. 3 is a horizontal section illustrating the stereoscopic image display apparatus.

FIG. 4 is a vertical section illustrating the stereoscopic image display apparatus.

FIG. 5 is a front view illustrating central parts of electronic image display panels.

FIG. 6 is a horizontal section illustrating a stereoscopic image display apparatus according to a second embodiment of the present invention.

FIG. 7 is a vertical section illustrating the stereoscopic image display apparatus.

FIG. 8 is a horizontal section illustrating a stereoscopic image display apparatus according to a third embodiment of the present invention.

### MODE OF IMPLEMENTING INVENTION

### (FIRST EMBODIMENT)

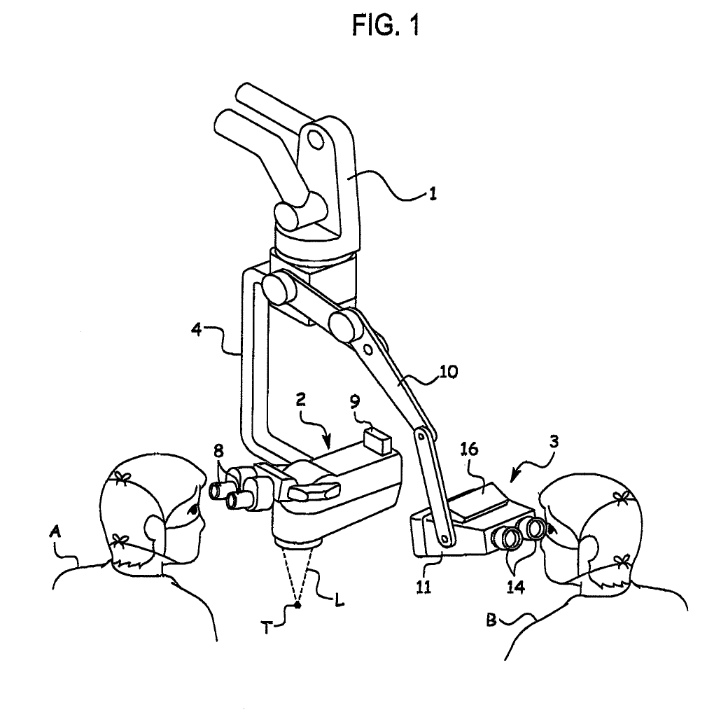

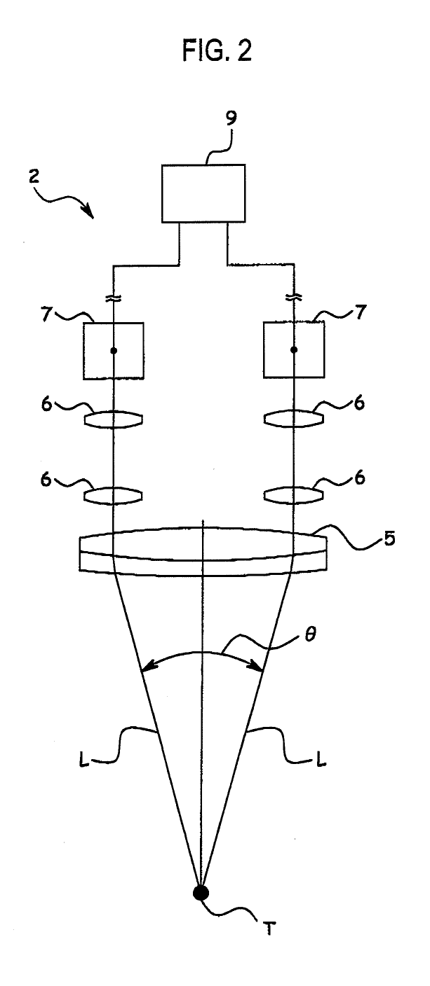

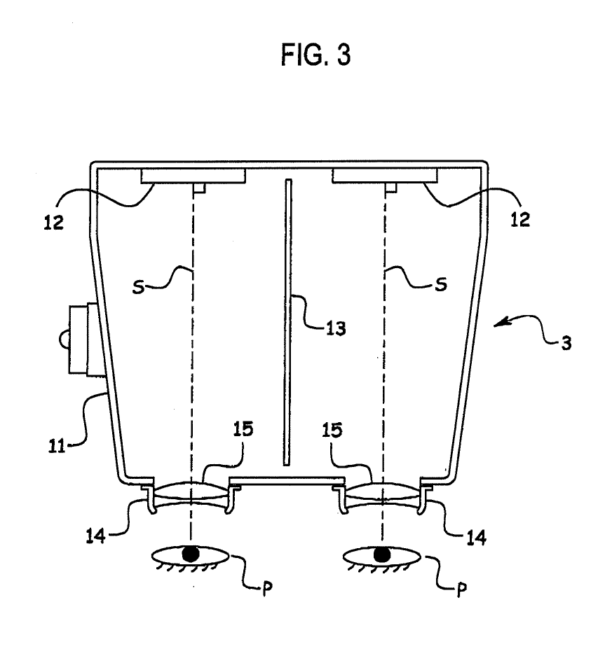

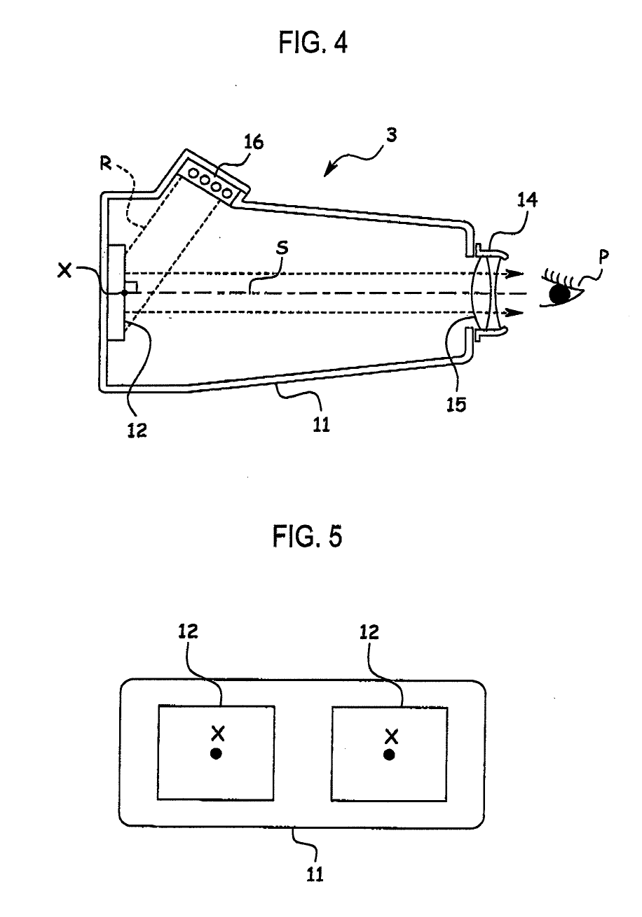

FIGS. 1 to 5 illustrate the first embodiment of the present invention. FIG. 1 illustrates a front link 1 of a stand apparatus (not illustrated) that supports a surgical microscope 2 and a stereoscopic image display apparatus 3. The surgical microscope 2 is operated by a main operator A and the stereoscopic image display apparatus 3 is operated by an assistant B.

The surgical microscope 2 is supported through a suspension arm 4 by the front link 1. The surgical microscope 2 includes an objective lens 5, zoom lenses 6, beam splitters 7, and the like. From an operation spot T, a light beam L is guided at a predetermined convergent angle of θ to the objective lens 5, is transmitted through the objective lens 5, and is separated into two systems of optical paths corresponding to left and right eyes P, respectively. Light rays of the separated beams pass through the zoom lenses 6 are reflected at the beam splitters 7 toward a rear side, bent at optical elements such as prisms (not illustrated) toward a front side, and finally guided to a pair of left and right eyepieces 8.

Through the pair of eyepieces 8, the main operator A is able to stereoscopically observe optical images of the operation spot T having a binocular parallax corresponding to the convergent angle of θ. In this explanation, a direction orthogonal to optical axes S of left and right eyepiece lenses 15 in an imaginary plane that contain the optical axes S is a left, right, or horizontal direction and a direction vertical to the imaginary plane is an upper or a lower direction.

A top part of the surgical microscope 2 is provided with a camera 9 capable of taking stereoscopic photographs. The camera 9 receives the pair of light beams L that are separated on the way in the surgical microscope 2 and photographs electronic images that are similar to the optical images observed by the main operator A. The camera 9 has a known stereoscopic adaptor (for example, Japanese Patent No. 2607828) and can singly photograph both of right- and left-eye electronic images.

On the other hand, the stereoscopic image display apparatus 3 is supported through an auxiliary arm 10 by the front link 1. The stereoscopic image display apparatus 3 has a casing 11 that incorporates a pair of left and right electronic image display panels 12 to display the pair of electronic images related to the operation spot T photographed with the camera 9 of the surgical microscope 2.

Each electronic image display panel 12 according to this embodiment is a one-inch reflective liquid crystal panel. At an upper part of the casing 11, a light source 16 is arranged to illuminate the electronic image display panels 12 from obliquely above. The light source 16 includes semiconductor light emitting elements such as white LEDs or organic ELs arranged in a plane. The position where the light source 16 is arranged is optional if the light source 16 does not block light from the electronic image panels 12 to the eyepiece lenses 15.

Inside the casing 11, there is a partition 13 to define spaces for the pair of electronic image display panels 12, respectively. Opposite to the electronic image display panels 12 in the casing 11, there is a pair of left and right eyepieces 14. The eyepieces 14 are movable in left and right directions relative to the casing 11, to adjust a pupil distance.

The eyepieces 14 have achromatic lenses serving as the eyepiece lenses 15 through which the left and right eyes P observe electronic images displayed on the electronic image display panels 12. Namely, illumination light R from the light source 16 hits the electronic image display panels 12 and reflected light therefrom is guided through the eyepiece lenses 15 to the left and right eyes P so that an electronic image is stereoscopically observed.

Optical axes S of the eyepiece lenses 15 are defined as being parallel to each other and are perpendicular to the surfaces of the electronic image display panels 12. Each optical axis S passes through a central part X of the electronic image display panel 12 that is a main observation point of the observer, i.e., the assistant B.

Accordingly, when observing the electronic image display panel 12, the visual axis of the eye P of the assistant will not form a large angle with respect to the electronic image display panel 12, and therefore, the assistant B can stereoscopically observe electronic images displayed on the electronic image display panels 12 at an original binocular parallax provided by the objective lens 5 of the surgical microscope 2. As a result, the assistant feels no eye fatigue or headache even when observing the images for a long time.

The reason why the optical axis S of the eyepiece lens 15 is defined as being perpendicular to the electronic image display panel 12 and agrees with the central part X is that the electronic image display panel 12 is made compact with the use of the reflective liquid crystal panel. The reflective liquid crystal panel is structurally easier to miniaturize than the transmissive liquid crystal panel having a backlight on the back face thereof. Compared with the transmissive liquid crystal panel, the reflective liquid crystal panel has a narrower pixel-to-pixel gap to make black grids inconspicuous and improve image quality.

The surface of each electronic image display panel 12 is directly illuminated with the illumination light R from the light source 16, so that the stereoscopic image display apparatus 3 has a simple structure in whole and is easy to manufacture.

### (SECOND EMBODIMENT)

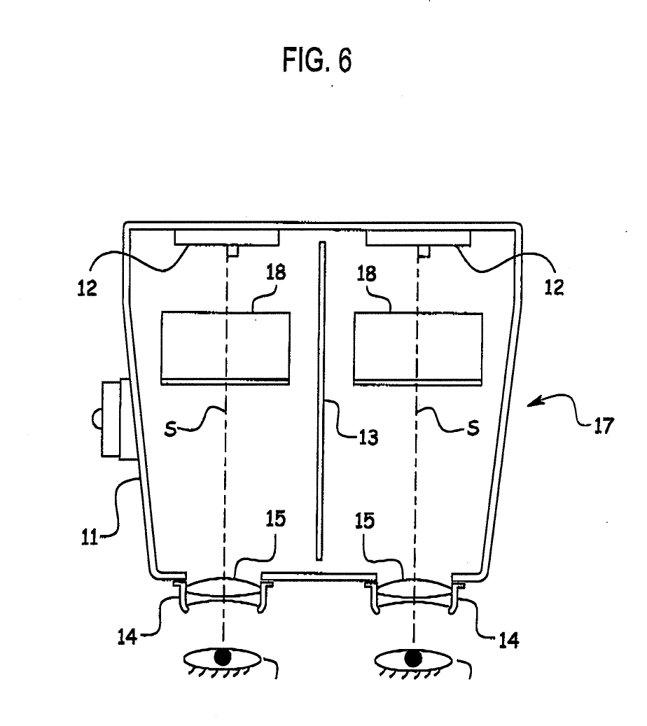

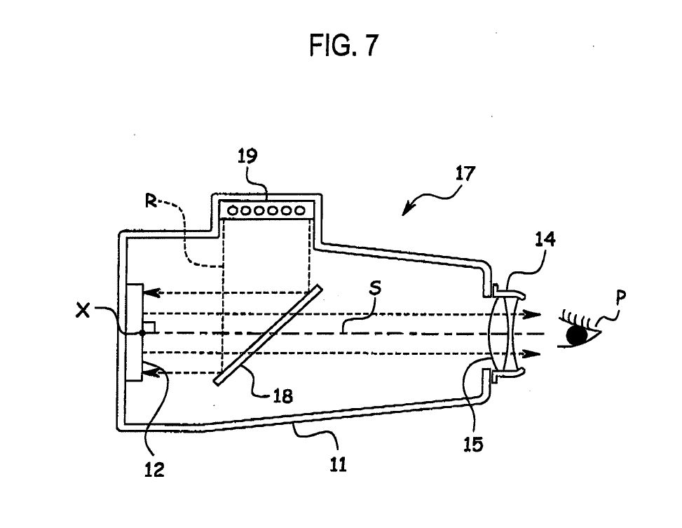

FIGS. 6 and 7 illustrate the second embodiment of the present invention. This embodiment has components that are similar to those of the first embodiment. Accordingly, like components are represented with common reference marks and overlapping explanations are omitted.

A stereoscopic image display apparatus 17 according to this embodiment arranges, on each optical axis S between an electronic image display panel 12 and an eyepiece lens 15, a half mirror (light branching unit) 18 slanted by 45 degrees in a vertical direction with respect to the optical axis S. The half mirror 18 allows illumination light R from a light source 19 to illuminate the electronic image display panel 12 from an optical axis direction. An image displayed on the electronic image display panel 12 passes through the half mirror 18 and reaches the eyepiece lens 15. The half mirror 18 branches light into transmitted light (straight light) and reflected light at a ratio of 50:50. Above each half mirror 18, the light source 19 made of white LEDs is arranged. The light sources 19 are arranged at an upper part, to form an upper light structure.

The illumination light R from each light source 19 straightly illuminates the half mirror 18. The half mirror 18 partly reflects the illumination light into light that travels in parallel with the optical axis S and perpendicularly hits the electronic image display panel 12. The illumination light R hits the electronic image display panel 12, reflected thereby, and travels along the optical axis S. The reflected light from the electronic image display panel 12 partly transmits through the half mirror 18, passes through the eyepiece lens 15, and reaches the eye P.

According to the present embodiment, the illumination light R of the light source 19 is reflected by the half mirror 18, to perpendicularly hit the electronic image display panel 12, thereby realizing uniform illumination and making an electronic image on the electronic image display panel 12 clearly viewable.

### (THIRD EMBODIMENT)

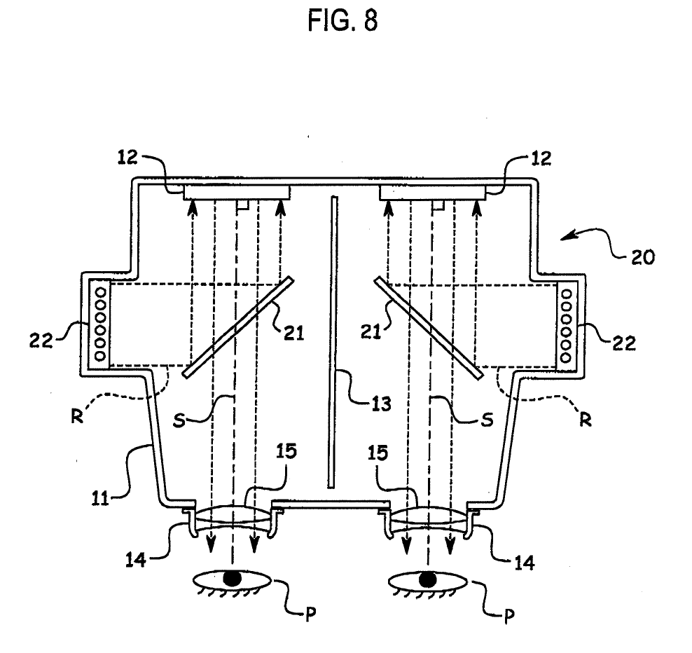

FIG. 8 illustrates the third embodiment of the present invention. This embodiment has components that are similar to those of the preceding embodiment.

A stereoscopic image display apparatus 20 according to the embodiment arranges, on each optical axis S between an electronic image display panel 12 and an eyepiece lens 15, a half mirror (light branching unit) 21 slanted by 45 degrees in a horizontal direction with respect to the optical axis S. On a horizontal side of each half mirror 21, there is arranged a light source 22 having white LEDs. The light sources 22 arranged sideward form a side light structure.

Like the preceding embodiment, the present embodiment reflects illumination light R from the light source 22 with the half mirror 21 so that the reflected light may perpendicularly hit the electronic image display panel 12. This realizes uniform illumination and makes an electronic image on the electronic image display panel 12 clearly viewable.

In the above-mentioned embodiments, the light branching unit is the half mirror 18 (21). Instead of this, a beam splitter is adoptable.

### EFFECT OF INVENTION

According to the present invention, the optical axis of the eyepiece lens is perpendicular to the corresponding electronic image display panel. Accordingly, an observer can stereoscopically observe electronic images displayed on the electronic image display panels at an original binocular parallax. As a result, the observer feels no eye fatigue or headache even when observing the images for a long time. Since each electronic image display panel is a reflective liquid crystal panel, the display apparatus can easily be miniaturized to form a structure in which the optical axis of each eyepiece lens is perpendicular to the corresponding electronic image display panel.

The optical axis of each eyepiece lens agrees with the central part of the corresponding electronic image display panel. Even when observing an edge part of the electronic image display panel, an observer can easily view the electronic image display panel without enlarging an angle between the visual line of the observer and the electronic image display panel.

Illumination light from the light source directly illuminates the surface of each electronic image display panel. Accordingly, the display apparatus has a simple structure and is easy to manufacture.

According to the present invention, the light branching unit partly reflects illumination light from the light source so that the reflected light hits the front surface of the electronic image display panel. This realizes uniform illumination and makes an electronic image on the electronic image display panel clearly viewable. Although the light branching unit is positioned between the electronic image display panel and the eyepiece lens, the reflected light from the electronic image display panel partly transmits through the light branching unit and reaches the eyepiece lens, and therefore, the light branching unit never bothers observation through the eyepiece lens.

### (United States Designation)

In connection with United States designation, this international patent application claims the benefit of priority under 35 U.S.C. 119(a) to Japanese Patent Application No. 2008-137799 filed on May 27, 2008, the entire contents of which are incorporated by reference herein.

1. A stereoscopic image display apparatus comprising a pair of left and right electronic image display panels disposed in a casing, to respectively display a pair of left and right electronic images having binocular parallax and a pair of left and right eyepiece lenses arranged in the casing opposite to the electronic image display panels, respectively, the electronic image display panels being observed through the corresponding eyepiece lenses, to observe a stereoscopic image, wherein:
an optical axis of each of the eyepiece lenses is defined as being perpendicular to the corresponding electronic image display panel; and
each of the electronic image display panels is a reflective liquid crystal panel whose surface is illuminated with illumination light from a light source.

2. The stereoscopic image display apparatus as set forth in claim 1, wherein
the optical axis of each eyepiece lens agrees with a central part of the corresponding electronic image display panel.

3. The stereoscopic image display apparatus as set forth in claim 1, wherein
the light source is arranged at a position proximate to the electronic image display panels, so that illumination light from the light source directly illuminates the surfaces of the electronic image display panels.

4. The stereoscopic image display apparatus as set forth in claim 1, comprising
a light branching unit arranged on the optical axis between the electronic image display panel and the eyepiece lens, so that illumination light from the light source illuminates the electronic image display panels through the light branching units, wherein
an image on the electronic image display panel reaches the eyepiece lens through the light branching unit.

5. The stereoscopic image display apparatus as set forth in claim 1, comprising
a light branching unit arranged between each electronic image display panel and the corresponding eyepiece lens, to form an angle of 45 degrees with respect to the optical axis of the eyepiece lens, and a light source oriented in a direction at an angle of 90 degrees with respect to the optical axes, wherein
illumination light from the light source is emitted toward each light branching unit, which partly branches the illumination light into a direction perpendicular to the electronic image display panel, so that reflected light from the electronic image display panel is transmitted through the light branching unit and is observed through the eyepiece lens.

6. The stereoscopic image display apparatus as set forth in claim 2 wherein
the light source is arranged at a position proximate to the electronic image display panels, so that illumination light from the light source directly illuminates the surfaces of the electronic image display panels.

7. The stereoscopic image display apparatus as set forth in claim 2, comprising
a light branching unit arranged on the optical axis between the electronic image display panel and the eyepiece lens, so that illumination light from the light source illuminates the electronic image display panels through the light branching units, wherein
an image on the electronic image display panel reaches the eyepiece lens through the light branching unit.

8. The stereoscopic image display apparatus as set forth in claim 2, comprising
a light branching unit arranged between each electronic image display panel and the corresponding eyepiece lens, to form an angle of 45 degrees with respect to the optical axis of the eyepiece lens, and a light source oriented in a direction at an angle of 90 degrees with respect to the optical axes, wherein
illumination light from the light source is emitted toward each light branching unit, which partly branches the illumination light into a direction perpendicular to the electronic image display panel, so that reflected light from the electronic image display panel is transmitted through the light branching unit and is observed through the eyepiece lens.
